(19) United States
(12) Patent Application Publication
(10) Pub. No.: US 2025/0005391 A1
(43) Pub. Date: Jan. 2, 2025

(54) SYSTEMS AND METHODS FOR DESIGNING DOPED CRYSTALLINE MATERIALS

(71) Applicant: Toyota Research Institute, Inc., Los Altos, CA (US)

(72) Inventors: Xiangyun Lei, Atlanta, GA (US); Weike Ye, Sunnyvale, CA (US); Xiangyu Yin, Pittsburgh, PA (US); Joseph Harold Montoya, Berkeley, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/216,782

(22) Filed: Jun. 30, 2023

(51) Int. Cl. G06N 5/04

(52) U.S. Cl. CPC G06N 5/04

(57) ABSTRACT

A reinforcement learning system for predicting a doped crystalline material and learning a doping policy for a dopant includes a processor and a memory communicably coupled to the processor. The memory has stored machine-readable instructions that, when executed by the processor, cause the processor to: i) dope a crystal graph representation for a crystalline material (crystal) with dopant atoms; ii) determine a state of the doped crystal; iii) move at least one of the dopant atoms along an edge of the crystal per a doping policy; iv) determine another state of the doped crystal and a reward accumulation of moving the at least one dopant atoms; v) update the doping policy; and repeat steps iii-v for a predetermined number of cycles.

### TECHNICAL FIELD

The present disclosure relates generally to machine learning and particularly to machine learning for doping crystalline materials.

### BACKGROUND

A dopant is a low concentration impurity (element) introduced into a material for the purpose of improving one or more properties (e.g., catalytic, electronic, and/or spectroscopic properties, among others) of the material. In addition, “doped materials” have traditionally been designed using experimental trial-and-error processes guided with expert (human) knowledge. However, such experimental trial-and-error processes can be time and cost intensive.

The present disclosure addresses issues related to designing doped materials, and other issues related to doped materials.

### SUMMARY

This section provides a general summary of the disclosure and is not a comprehensive disclosure of its full scope or all of its features.

In one form of the present disclosure, a system includes a processor and a memory communicably coupled to the processor. The memory has stored machine-readable instructions that, when executed by the processor, cause the processor to: i) generate a crystal graph representation for a crystalline material (crystal) with dopant atoms; ii) determine a state of the doped crystal; iii) move at least one of the dopant atoms along an edge of the crystal graph per a doping policy; iv) determine an updated state of the doped crystal and a reward accumulation of moving the at least one dopant atoms; v) update the doping policy; and repeat steps iii-v for a predetermined number of cycles.

In another form of the present disclosure, a method includes: i) reading a crystal graph for an inorganic material and a doping policy for doping the inorganic material from a memory communicably coupled to and using a processor; ii) inserting dopant atoms at a first set of atom sites in the crystal graph; iii) calculating a state of the doped crystal graph; iv) moving the dopant atoms along connecting edges of the crystal graph to a subsequent set atom sites in the crystal graph; v) calculating a subsequent state of the dopant atoms and an accumulated reward of moving the dopant atoms along the at least one edge of the crystal graph; vi) updating the doping policy; vii) repeating steps iv-vi for a predetermined number of cycles such that a learned doping policy is provided; and viii) inferencing a doped crystalline material using the learned doping policy.

In still another form of the present disclosure, a system includes a processor and a memory communicably coupled to the processor. The memory includes stored machine-readable instructions that, when executed by the processor, cause the processor to read a crystal graph for a crystalline material and a doping policy for doping the crystalline material, the crystal graph having the form G={V, E}, where V=[yᵢ, xᵢ), i=1, . . . , N} is a set of nodes in the crystal graph and E={e_{i,j}|i,j∈{1, . . . , N}} is a set of edges representing bonds in the crystal graph. The memory also includes stored machine-readable instructions that, when executed by the processor, cause the processor to: i) insert dopant atoms in the crystal graph; ii) determine a state of the crystal graph; iii) move at least one of the dopant atoms along connecting edges of the crystal graph per the doping policy; iv) determine another state and an accumulated reward of moving the at least one of the dopant atoms along the connecting edges; v) update the doping policy; vi). repeat steps i-v until a predefined number of steps are completed such that a learned doping policy is provided; and vii) inference a doped crystalline material using the learned doping policy.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 illustrates an example of a reinforcement learning system for doping a crystalline material according to the teachings of the present disclosure;

FIG. 2 shows a flow chart for a reinforcement learning method using the system illustrated in FIG. 1 for learning a doping policy according to the teachings of the present disclosure;

FIG. 3 shows a flow chart for another reinforcement learning method using the system illustrated in FIG. 1 for learning a doping policy according to the teachings of the present disclosure; and

FIG. 4 shows a flow chart for a reinforcement learning method using the system illustrated in FIG. 1 for predicting or inferencing a doped crystalline material after learning a doping policy according to the teachings of the present disclosure.

### DETAILED DESCRIPTION

The present disclosure provides a reinforcement learning (RL) system and an RL method for learning a strategy for how dopant atoms distribute in crystalline materials and/or predicting a distribution of dopant materials in crystalline materials such that a doped crystalline material chemical composition has or exhibits at least one enhanced material property compared to the crystalline material without doping. As used herein, the term “doping” refers to inserting or adding a low concentration (e.g., less than 1.0 weight percent) of at least one element and/or crystalline defect (also known as an impurity and referred to herein as a “dopant”) to a crystalline material, and the phrase “doped crystalline material” refers to a crystalline material with a low concentration (e.g., less than 1.0 weight percent) of at least one element and/or crystalline defect. Non-limiting examples of the material property include a formation energy, a catalytic activity, an electronic band gap, an elastic modulus, and an electrical conductivity, among others.

In one form of the present disclosure, the RL system and RL method learn a doping policy (strategy) for the movement and/or distribution of dopant atoms within a given crystalline material and the learned doping policy is used for or extrapolated to a large scale system (e.g., a relatively large unit cell). In some variations, the learned doping policy is used for or extrapolated to doping a different crystalline material with the same dopant. In the alternative, or in addition to, the learned doping policy is used for or extrapolated to doping a different crystalline material with a different concentration (amount) of the same dopant, doping different crystalline materials with similar chemistries with the same dopant and/or a different dopant, and/or doping the same crystalline material with a different dopant.

The RL system and RL method use a crystal graph representation (also referred to herein simply as “crystal graph”) to represent or symbolize a crystalline material. The crystal graph includes nodes that represent atoms of the crystalline material and edges between the nodes that represent bonds between the atoms. In addition, a “nearest neighbor node” is defined as a node adjacent to another node that has an edge connecting itself and the adjacent node. The RL system and the RL method introduce a given number (concentration) of dopant atoms into the crystal graph (e.g., by manipulating identities of corresponding nodes), determine a state of the doped crystal (i.e., a state of the doped crystal as represented by the crystal graph), and move the dopant atoms along edges of the crystal graph per a doping policy. As used herein, the phrase “doping policy” refers to a strategy for moving dopant atoms along edges of a crystal graph after, and based on, a state of a doped crystal is determined. Stated differently, a doping policy is a strategy for moving the dopant atoms within the crystal graph and the doping policy is sequentially updated and/or revised after each move of the dopant atoms within the crystal graph during a training phase.

The RL system and RL method also determine the state of the doped crystal after moving the dopant atoms, a reward for moving the dopant atoms, and a reward accumulation for all previous moves of the dopant atoms during the training phase. As noted above, and during the training phase, the doping policy is updated with the state and the reward accumulation, and the updated doping policy directs each subsequent move of the dopant atoms as function of the most recent state and reward accumulation. This cycle, i.e., move dopant atoms-determine state and reward accumulation-update policy-move dopant atoms continues until a predefined criterion is met or exceeded. For example, in some variations this cycle continues for a predetermined number of cycles, e.g., until an optimized reward accumulation is determined or obtained and a learned doping policy is provided.

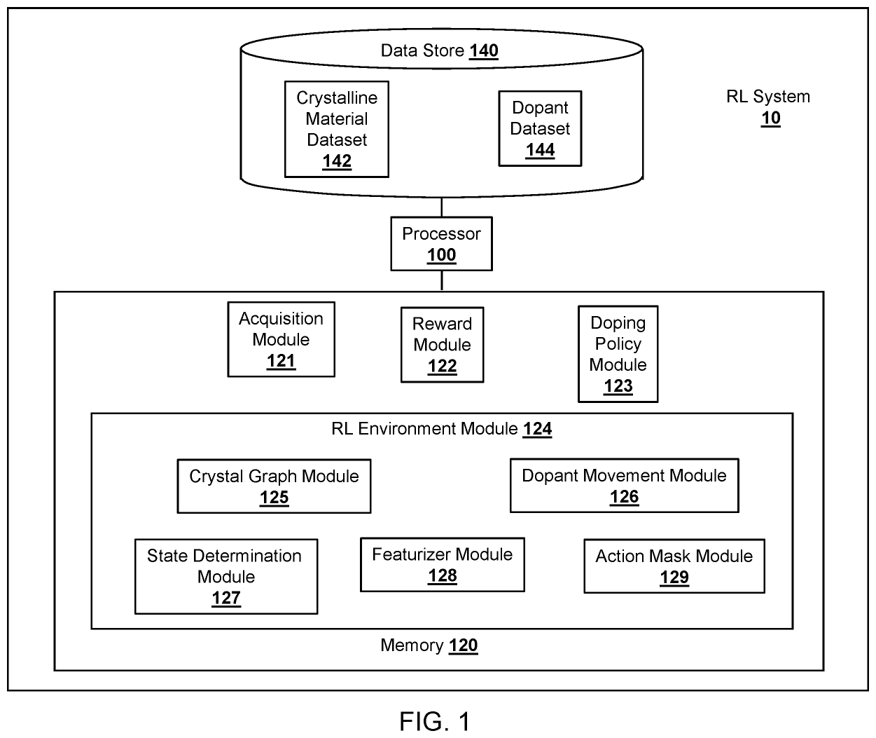

Referring now to FIG. 1, a RL system 10 for doping a crystalline material and learning a doping policy is illustrated. The RL system 10 is shown including one or more processors 100 (referred to herein simply as “processor 100”), a memory 120 and a data store 140 communicably coupled to the processor 100. It should be understood that the processor 100 can be part of the RL system 10, or in the alternative, the RL system 10 can access the processor 100 through a data bus or another communication path.

The memory 120 is configured to store an acquisition module 121, a reward module 122, and a doping policy module 123. In addition, in some variations the memory 120 is configured to store a RL environment module 124 that can include one or more of a crystal graph module 125, a dopant movement module 126 (also known as and referred to herein as an “agent 126”), a state determination module 127, a featurizer module 128, and/or an action mask module 129. And while FIG. 1 illustrates the crystal graph module 125, agent 126, state determination module 127, featurizer module 128, and action mask module 129 as sub-modules of the RL environment module 124, in some variations the crystal graph module 125, agent 126, state determination module 127, featurizer module 128, and action mask module 129 are not sub-modules of the RL environment module 124.

The memory 120 is a random-access memory (RAM), read-only memory (ROM), a hard-disk drive, a flash memory, or other suitable memory for storing the acquisition module 121, the reward module 122, doping policy module 123, the crystal graph module 125, the agent 126, the state determination module 127, the featurizer module 128, and the action mask module 129 (referred to herein as the “modules 121-129”). Also, the modules 121-129 are, for example, computer-readable instructions that when executed by the processor 100 cause the processor(s) to perform the various functions disclosed herein.

In some variations the data store 140 is a database, e.g., an electronic data structure stored in the memory 120 or another data store. Also, in at least one variation the data store 140 in the form of a database is configured with routines that can be executed by the processor 100 for analyzing stored data, providing stored data, organizing stored data, and the like. Accordingly, in some variations the data store 140 stores data used by one or more of the modules 121-129. For example, and as shown in FIG. 1, in at least one variation the data store stores a crystalline material dataset 142 and dopant dataset 144. In some variations the crystalline material dataset 142 includes a listing of a plurality of crystalline material compositions, including crystalline materials formed from a single element and/or crystalline materials formed from more than one element (e.g., an alloy, an intermetallic, a ceramic, among others), and the dopant dataset 144 includes a plurality of dopants, i.e., elements that can be introduced into a crystalline material for the purpose of doping the crystalline material. It should be understood that a dopant(s) to be introduced into a crystalline material can be selected from the dopant dataset 144 using domain (expert) knowledge of the dopant(s) and/or the crystalline material. In the alternative, a crystalline material dataset 142 and/or a dopant dataset 144 cannot be included or stored in the data store 140 and a crystalline material and/or a dopant can be selected for study using the RL system 10 using expert knowledge, i.e., selected by an individual.

Crystalline materials selected using expert knowledge and/or stored in the crystalline material dataset 142 can include metallic and ceramic systems for which doping thereof is desired. For example, and without limitation, the crystalline material dataset 142 and/or crystalline materials selected using expert knowledge can include materials such as alloys, intermetallics, semiconductors, semimetals, and dielectrics, among others. And dopants in the dopant dataset 144 include aluminum (Al), antimony (Sb), arsenic (As), beryllium (Be), bismuth (Bi), boron (B), carbon (C), chlorine (CI), chromium (Cr), fluorine (F), gallium (Ga), germanium (Ge), gold (Au), indium (In), iodine (I), lithium (Li), magnesium (Mg), nitrogen (N), phosphorus (P), platinum (Pt), selenium (Se), sodium (Na), sulfur(S), tellurium (Te), tin (Sn), and zinc (Zn), among others.

The acquisition module 121 can include instructions that function to control the processor 100 to select a crystalline material from the crystalline material dataset 142 and a dopant from the dopant dataset 144.

In one form of the present disclosure, the modules 121-129 can include instructions that function to control the processor 100 to perform or execute one or more of the following: select a crystal graph from the crystal graph module 125 that corresponds to or represents a crystalline material selected from the crystalline material dataset 142; form a crystal graph using the crystal graph module 125 that corresponds to or represents a crystalline material selected from the crystalline material dataset 142; insert a given number of atoms (i.e., representations of atoms) of a dopant (dopant atoms) into the crystal graph per instructions from the doping policy module 123; calculate a state of the crystal graph with the given number of dopant atoms inserted therein using the state determination module 127; move one or more of the dopant atoms along one or more edges of the crystal graph per instructions from the doping policy module 123, the dopant movement module 126, the featurizer module 128, and/or action mask module 129; calculate a state of the crystal graph after moving one or more dopant atoms using the state determination module 127; calculating a reward for the movement of the one or more dopant atoms using the reward module 122; calculate a reward accumulation for all movements of the one or more dopant atoms; and update the doping policy as a function of the calculated state, the calculated reward, and/or the calculated reward accumulation. In some variations, the reward accumulation is a function of a property of the doped crystal graph, for example, a formation energy, a catalytic activity, an electronic band gap, an elastic modulus, and/or an electrical conductivity, among others, of the doped crystal graph.

In some variations, the acquisition module 121 is configured to handle or execute communication within the RL system, e.g., read data from a dataset, and the reward module 122 includes reward recording module configured accumulating a reward for the movement of dopant atoms within a crystalline material. Also, in at least one variation the doping policy module 123 includes a dopant atom initialization module configured to provide an initial set of atom sites within a given crystalline material where a plurality of dopant atoms are to be inserted and positioned, and a trainable policy module configured to trained for the movement of dopant atoms.

In some variations, the crystal graph module 125 includes a graph generation module configured to convert a crystalline material into a graph, a graph update module configured to update the graph with new dopant atom positions, and action mask module configured to limit or constrain movement of the dopant atoms. For example, in at least one variation the action mask module constrains movement of dopant atoms on certain edges of the graph based on human knowledge of which atom sites dopant atoms can or cannot occupy.

In some variations, the crystal graph module 125 provides or forms a crystal graph for a selected undoped crystalline material having the form:

G={V,E} Eq.1

where V={vᵢ=(yᵢ, xᵢ), i=1, . . . , N} is a set of nodes (atom sites) in the crystal graph G, yᵢ denotes the atom type, and xᵢ denotes the cartesian coordinates of the atom cites, N is the number of nodes in the crystal graph G. E={e_{i,j}|i,j∈{1, . . . , N}} is a set of edges representing bonds in the crystal graph G, and e_{i,j} is a representation of the bond between sites i and j. In addition, in at least one variation the state determination module 127 determines the state of the dopant atoms as being defined by the crystal graph G with dopants, i.e.:

G^{D}=(V^{D},E)

where V^{D} is the set of nodes that contain dopants.

In some variations, movement (action) of a doped atom (α_{i,j}(G)) is defined as a function of the crystal graph G that replaces the atom type of a neighbor node with that of a dopant atom, and changes the atom type of the dopant atom's current node back to that of the undoped crystal. Particularly, movement (action) of a doped atom can be defined as:

$${a}_{i , j} ( G ) = \{ set {y}_{j} = {y}^{D} , {y}_{i} = {y}_{i}^{U} , if j ∈ {N}_{i , {y}^{D}} \} \qquad Eq . 2$$

where y^{D} is the atom type of the dopant, yᵢ^{U} is the atom type of site i, and N_{i,y}_{^{D}} is the space of all permitted destination nodes given the site symmetry and the dopant atom type, or other constraints.

In variations where the actions α_{i,j}(G) are defined as above, the state transition function T is defined as the function that takes the crystal graph from one state to the next and is consists of a series of action functions is defined as:

$$T ( {G}_{t} ) = ( {a}_{1} \cdot {a}_{2} … {a}_{k} ) ( {G}_{t} ) = {G}_{t + 1} . \qquad Eq . 3$$

In this context, the reward r for a particular movement or step t (i.e., rₜ) of the dopant atom is a function of the crystal graph at step t (i.e., Gₜ) and t−1 (i.e., Gₜ₋₁). And in some variations, this reward is a function of the predicted difference between G, and Gₜ₋₁, i.e.:

rₜ=f(Gₜ,Gₜ₋₁). Eq. 4

In some variations, the given number of dopant atoms are randomly inserted into the crystal graph, while in other variations, the dopant atoms are inserted into the crystal graph with a bias provided by an initial dopant insertion policy doping policy. For example, in some variations dopant atoms are known to prefer given atom and/or crystal structure sites within a given crystalline material, and in such variations the doping policy can bias inserting (positioning) dopant atoms at such preferred atom cites. In other variations, dopant atoms are known not to prefer or to be generally prevented from occupying given atom and/or crystal structure cites within a given crystalline material, and in such variations the doping policy can prevent or reduce inserting (positioning) dopant atoms at such non-preferred atom cites.

In some variations the agent generates an agent mask [symbol] ^{D} with a collection of binary vectors that indicate whether or not a local move is desired or biased. For example, at a time step ‘t’, the RL agent observes a state G₍ₜ₊₁₎^{D}, generates a new action α₍ₜ₊₁₎^{D}, and an action mask [symbol] ₍ₜ₊₂₎^{D}={bₖ^{D}∈ [symbol] , k=1, . . . , N^{D}}, where bₖ^{D} is a binary vector indicating whether or not each action in the action space is wanted, is provided for the environment. Also, the action mask [symbol] ₍ₜ₊₂₎^{D} is then used to guide the generation process of the next action α₍ₜ₊₂₎^{D} such that unwanted actions are not executed. In some variations, this is achieved by modifying input values of a softmax layer in a neural network model of the doping policy such that output probabilities of choosing one or more actions are near zero.

And in some variations, calculating the state of a crystal graph with a given number of dopant atoms inserted therein can includes calculating states of the dopant atoms after their movement, and in at least one variation the state of the dopant atoms and the movement of the dopant atoms are a function of the number of the dopant atoms inserted into the crystal graph and are independent of a size of a unit cell of the crystal graph.

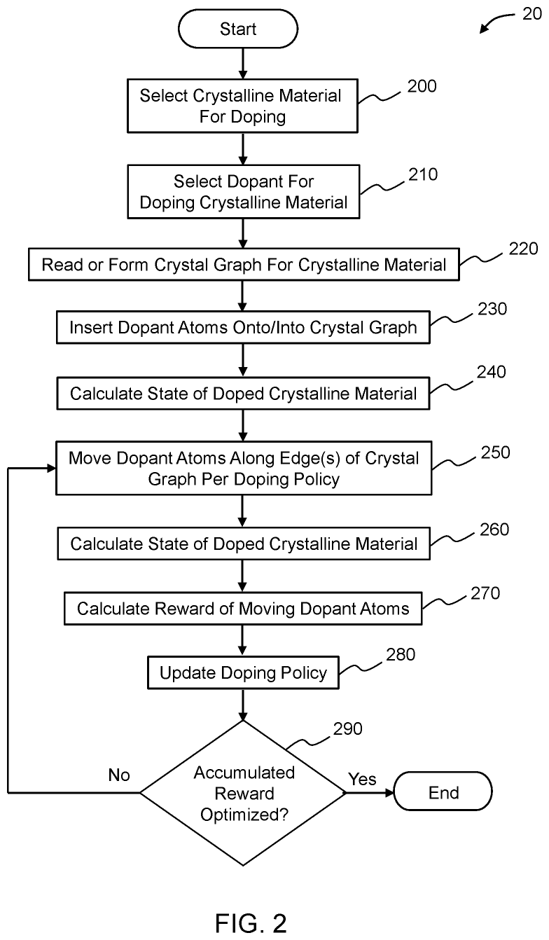

Referring now to FIG. 2, a method 20 for learning a doping policy for a crystalline material and one or more material properties includes selecting a crystalline material for doping at 210 and selecting a dopant for doping the selected crystalline material at 220. In some variations, the crystalline material is selected from a crystalline material dataset and/or the dopant is selected from a dopant dataset, while in other variations, the crystalline material is selected using expert knowledge and/or dopant is selected using domain (expert) knowledge.

The method 20 further includes reading a crystal graph from a crystal graph dataset or forming a crystal graph for the crystalline material at 220 and inserting dopant atoms (i.e., representation(s) of the dopant atoms) on or into the crystal graph at 230. The state of the doped crystalline material (crystal graph) is calculated at 240, the dopant atoms are moved along one or more edges of the crystal graph per a doping policy at 250, and the stated of the doped crystalline material is calculated again at 260 and a reward and/or an accumulated reward for moving the dopant atoms at 250 is calculated at 270.

The method 20 updates the doping policy at 280, e.g., as a function of the state calculated at 260 and/or the reward and/or accumulated reward calculated at 270. And whether or not the accumulated reward has been optimized is determined at 290. If the accumulated reward is determined not to be optimized at 280 (i.e., ‘No’), the method 20 returns to 250 and the dopant atoms are moved again. And this cycle, i.e., 250-260-270-280-290-250 continues until the accumulated reward is determined to be optimized at 290 (i.e., ‘Yes’), a learned doping policy has been provided, and the method ends. Non-limiting examples of the accumulated reward being optimized include performing or executing the cycle 250-260-270-280-290-250 a predetermined number of times, reaching or exceeding a predetermined value for the accumulated award, reaching a minimum value for the accumulated award with additional cycles resulting in an increase in the accumulated reward, and reaching a maximum value for the accumulated reward with additional cycles resulting in a decrease in the accumulated reward, among others.

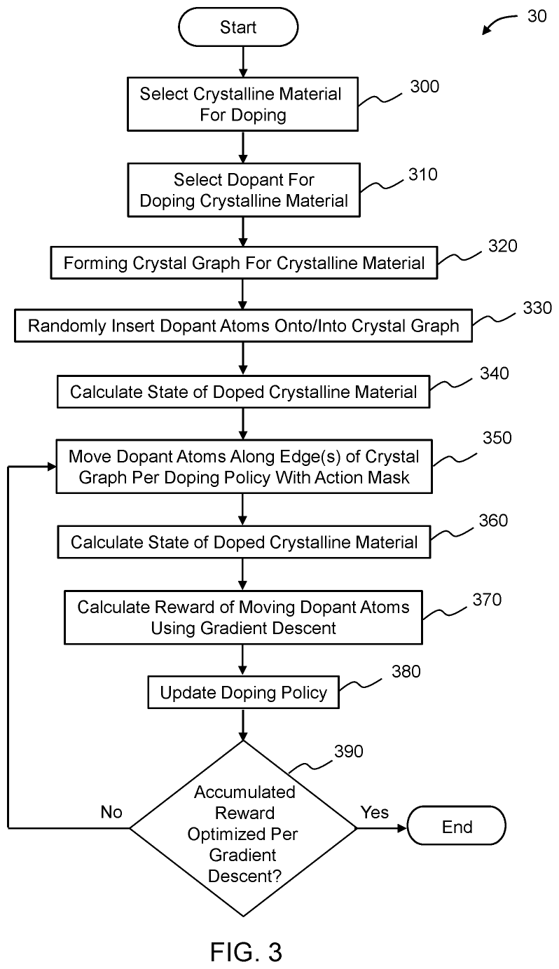

Referring to FIG. 3, another method 30 for learning a doping policy for a crystalline material and one or more material properties includes selecting a crystalline material for doping at 300 and selecting a dopant for doping the selected crystalline material at 310. In some variations, the crystalline material is selected from a crystalline material dataset and/or the dopant is selected from a dopant dataset, while in other variations, the crystalline material is selected using expert knowledge and/or dopant is selected using domain knowledge.

The method 30 further includes reading a crystal graph from a crystal graph dataset or forming a crystal graph for the crystalline material at 320 and randomly inserting dopant atoms (i.e., representation(s) of the dopant atoms) on or into the crystal graph at 330. The state of the doped crystalline material (crystal graph) is calculated at 340, the dopant atoms are moved along one or more edges of the crystal graph and prevented from moving along predefined edges of the crystal graph per a doping policy with an action mask at 350, the stated of the doped crystalline material is calculated again at 360, and a reward and/or an accumulated reward for moving the dopant atoms at 350 is calculated at 370.

The method 30 updates the doping policy at 380, e.g., as a function of the state calculated at 360 and/or the reward and/or accumulated reward calculated at 370, and whether or not the accumulated reward has been optimized using gradient descent is determined at 390. If the accumulated reward is determined not to be optimized at 380 (i.e., ‘No’), the method 30 returns to 350 and the dopant atoms are moved again. This cycle, i.e., 350-360-370-380-390-350, continues until the accumulated reward is determined to be optimized at 390 (i.e., ‘Yes’), a learned doping policy has been provided, and the method ends.

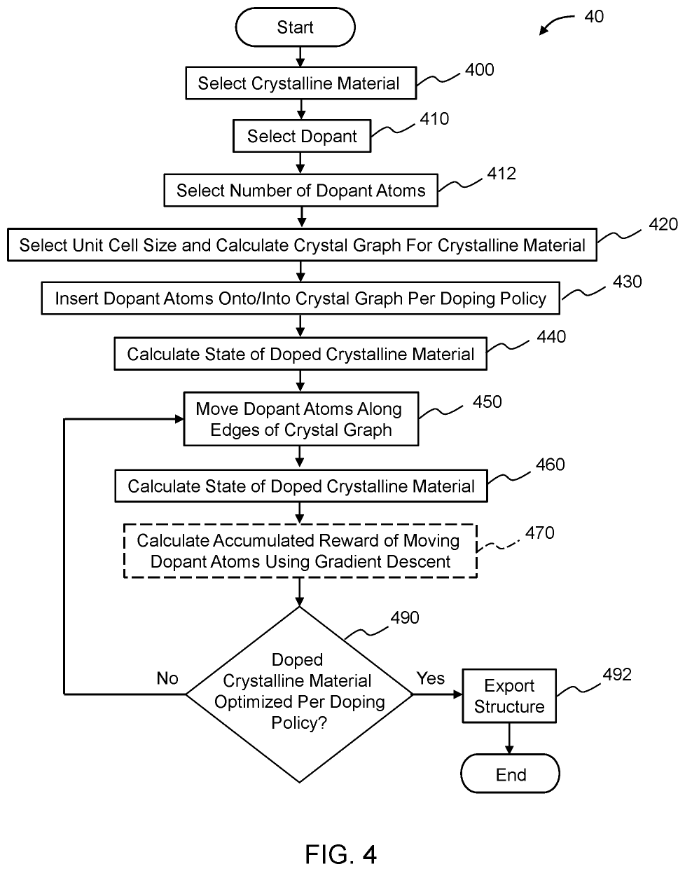

Referring to FIGS. 1 and 4, a method 40 for predicting or inferencing a doped crystalline material after learning a doping policy according to the teachings of the present disclosure is shown. The method 40 includes selecting a crystalline material from the crystalline material dataset 142 at 400, selecting a dopant for doping the selected crystalline material 410, and selecting a number of dopant atoms at 412. In some variations, the dopant is selected from the dopant dataset 144, while in other variations, the dopant is selected using domain knowledge.

The method 40 selects a unit cell size for the crystalline material and calculates a crystal graph for the unit cell at 420 using the crystal graph module 125 and Equation 1 above before inserting the selected number of dopant atoms into the crystal graph per a doping policy at 430. The method includes calculating the state of the doped crystalline material at 44 using the state determination module 127 and Equation 2 above. At 450, the method moves the dopant atoms along edges of the crystal graph at 450 using the dopant movement module 126 and Equation 3 above, and based on input from the doping policy module 123, featurizer module 128, and/or action mask module 129. For example, the featurizer module 128 can provide features (e.g., nearest neighbor atom types, nearest neighbor atom electronic configuration, among others) and/or the action mask module 129 can provide prohibited moves for the dopant atoms to doping policy module 123, and based on this provided information the doping policy module instructs the dopant movement module 126 where to move the dopant atoms for the next step.

The state determination module 127 calculates the state of the doped crystal graph at 460 using Equation 2 and whether or not the learned crystalline structure with the dopant atoms has been optimized is determined at 490. And while not required, in some variations the method 40 includes calculating an accumulated reward of moving dopant atoms using gradient descent at 470. That is, in the inference phase (i.e., inferencing of the doped crystalline material after learning the dopant movement policy) accumulating the reward of moving dopant atoms in order to optimize the doping policy is not needed, but can be performed to track progress of the doped crystalline material.

If the doped crystalline material is determined not to be optimized per the doping policy at 490 (i.e., ‘No’), the method 40 returns to 450 and continues this cycle i.e., 450-460-490-450, continues until the doped crystalline material is determined to be optimized at 490 (i.e., ‘Yes’). And when the doped crystalline material is determined to be optimized per the doping policy at 490, the learned crystalline structure with the dopant atoms (also referred to herein as a “learned doped crystalline structure” and shown simply as “structure” in FIG. 4) is exported at 492. In some variations, the learned doped crystalline structure is exported for use in manufacturing a doped material. In the alternative, or in addition, in some variations the learned doped crystalline material is exported for study and/or investigation of the dopant atoms and/or the crystalline material.

In view of the above, it should be understood that the RL systems and RL methods disclosed herein provide for enhanced discovery of doped crystalline materials and enhanced strategies of discovering doped crystalline materials. In addition, the RL systems and RL methods disclosed herein reduce the time and cost of doped crystalline material exploration and development. For example, and as described above, the RL system with the processor and memory coupled to the processor and storing machine-readable instructions provide for simulation of inserting dopant atoms into a crystalline material, calculating a state of doped crystalline material, moving the dopants atoms within the crystalline material, calculating another state of doped crystalline material, and calculating an accumulated reward resulting from movement of the dopant atoms. The most recent calculate state and accumulated reward are sued to update a doping policy (strategy) and the doping policy then determines the next move of the dopant atoms within the crystalline material. By updating the doping policy with the most recent state and the most recent accumulated reward, the doping policy learns how to dope the crystalline material with a given dopant and how the given dopant effects one or more properties of the crystalline material. In addition, the doping policy learns how the given dopant reacts or behaves within the crystalline material such that the doping policy for the given dopant can be applied to different crystalline materials.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A system comprising:
a processor; and
a memory communicably coupled to the processor and storing machine-readable instructions that, when executed by the processor, cause the processor to:
i) dope a crystal graph for a crystalline material with dopant atoms;
ii) determine a state of the doped crystal graph;
iii) move at least one of the dopant atoms along an edge of the crystal graph per a doping policy;
iv) determine another state of the doped crystal graph and a reward accumulation of moving the at least one dopant atoms;
v) update the doping policy; and
repeat steps iii-v for a predetermined number of cycles.

2. The system according to claim 1, wherein the crystal graph for the crystalline material is defined by the expression:
G={V,E}
where V=[(yᵢ, x₁), i=1, . . . , N} is a set of nodes in the crystal graph; and
where E={e_{i,j}|i,j∈{1, . . . , N}} is a set of edges representing bonds in the crystal graph.

3. The system according to claim 2, wherein the state of the doped crystal includes calculating states of the dopant atoms after movement of the at least one of the dopant atoms along at least one edge of the crystal.

4. The system according to claim 3, wherein the state of the dopant atoms is defined as the crystal graph with the dopant atoms:
G^{D}=(V^{D},E)
where V^{D} is the set of nodes that contain dopants.

5. The system according to claim 3, wherein the dopant atoms are moved between nearest neighbor nodes of the crystal graph.

6. The system according to claim 3, wherein the nearest neighbor nodes of the crystal graph are connected with an edge of the crystal graph.

7. The system according to claim 5, wherein the movement of the dopant atoms along the edge of the crystal is defined as:
$${a}_{i , j} ( {G}^{U} ) = \{ set {y}_{j} = {y}^{D} , {y}_{i} = {y}_{i}^{U} , if j ∈ {N}_{i , {y}^{D}} \}$$
where y^{D} is the atom type of the dopant, yᵢ^{U} is the atom type of site j, and N_{i,y}_{^{D}} is the space of all permitted destination nodes.

8. The system according to claim 5, wherein the state of the dopant atoms and the movement of the dopant atoms are a function of a number of the dopant atoms inserted into the crystal graph and are independent of a size of unit cell of the crystal graph.

9. The system according to claim 1, wherein a reward for the reward accumulation is defined by:
rₜ=f(Gₜ,Gₜ₋₁)
where rₜ is the reward at step t, Gₜ is the state of the crystal graph at step t, and Gₜ₋₁ is the state of the crystal graph at step t−1.

10. The system according to claim 9, wherein the reward is a function of a property of the doped crystal graph selected from the group consisting of a formation energy, a catalytic activity, an electronic band gap, an elastic modulus, and an electrical conductivity.

11. The system according to claim 1, wherein the machine-readable instructions, when executed by the processor, cause the processor to prevent the dopant atoms from moving along predefined edges of the crystal graph.

12. A method comprising:
i) reading a crystal graph for an inorganic material and a doping policy for doping the inorganic material from a memory communicably coupled to and using a processor;
ii) inserting dopant atoms at a first set of atom sites in the crystal graph;
iii) calculating a state of the dopant atoms;
iv) moving the dopant atoms along at least one edge of the crystal graph to a subsequent set atom sites in the crystal graph;
v) calculating a subsequent state of the dopant atoms and a reward of moving the dopant atoms along the at least one edge of the crystal graph;
vi) updating the doping policy;
vii) repeating steps iv-vi for a predetermine number of cycles such that a learned doping policy is provided; and
viii) inferencing a doped crystalline material using the learned doping policy.

13. The method according to claim 12, wherein the crystal graph read from the memory is:
G={V,E}
where V=[(yᵢ, x₁), i=1, . . . , N} is a set of nodes in the crystal graph; and
where E={e_{i,j}|i,j∈{1, . . . , N}} is a set of edges representing bonds in the crystal graph.

14. The method according to claim 13, wherein the state of the dopants is defined as the crystal graph with dopants:
G^{D}=(V^{D},E)
where V^{D} is the set of nodes that contain dopants.

15. The method according to claim 14, wherein moving the dopant atoms along the edge of the crystal graph is defined as:
$${a}_{i , j} ( {G}^{U} ) = \{ set {y}_{j} = {y}^{D} , {y}_{i} = {y}_{i}^{U} , if j ∈ {N}_{i , {y}^{D}} \}$$
where y_{D} is the atom type of the dopant, yᵢ^{U} is the atom type of site j, and N_{i,y}_{^{D}} is the space of all permitted destination nodes.

16. The method according to claim 12, wherein the reward is defined by:
rₜ=f(Gₜ,Gₜ₋₁)
where rₜ is the reward at step t, Gₜ is the state of the crystal graph at step t, and Gₜ₋₁ is the state of the crystal graph at step t−1.

17. The method according to claim 16, wherein the reward is a function of a property of the crystal graph selected from the group consisting of a formation energy, a catalytic activity, an electronic band gap, an elastic modulus, and an electrical conductivity.

18. The method according to claim 12 further comprising calculating an optimized doped crystalline material using the learned doping policy.

19. A system comprising:
a processor; and
a memory communicably coupled to the processor and storing machine-readable instructions that, when executed by the processor, cause the processor to:
i) read a crystal graph for a crystalline material and a doping policy for doping the crystalline material, the crystal graph defined by the expression:
G={V,E}
where V=[(yᵢ, xᵢ), i=1, . . . , N} is a set of nodes in the crystal graph; and
where E={e_{i,j}|i,j∈{1, . . . , N}} is a set of edges representing bonds in the crystal graph;
ii) insert dopant atoms in the crystal graph;
iii) determine a state of the dopant atoms;
iv) move at least one of the dopant atoms along an edge of the crystal graph per the doping policy;
v) determine another state and an accumulated reward of moving the dopant moved along the edge;
vi) update the doping policy; and
vii). repeat steps iv-vi until a predefined number of steps are completed such that a learned doping policy is provided; and
viii) inference a doped crystalline material using the learned doping policy.

20. The system according to claim 19, where the state of the dopant atoms is defined as the crystal graph with dopant:
G^{D}=(V^{D},E)
where V^{D} is the set of nodes that contain dopants, and the move of the dopant atoms along the edge of the crystal graph is defined as:
$${a}_{i , j} ( {G}^{U} ) = \{ set {y}_{j} = {y}^{D} , {y}_{i} = {y}_{i}^{U} , if j ∈ {N}_{i , {y}^{D}} \}$$
where y^{D} is the atom type of the dopant, yᵢ^{U} is an atom type of site i, and N_{i,y}_{^{D}} is the space of all permitted destination nodes.
